(19) United States
(12) Patent Application Publication
(10) Pub. No.: US 2007/0108840 A1
(43) Pub. Date: May 17, 2007

(54) Electronic controlling device and a method of controlling the same

(75) Inventors: Kenji Amada, Kanagawa (JP); Hiroyuki Ikeda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/591,517

(22) Filed: Nov. 2, 2006

(30) Foreign Application Priority Data
Nov. 11, 2005 (JP) 2005-327195

(51) Int. Cl. B60L 1/00

(52) U.S. Cl. 307/9.1

(57) ABSTRACT

An electronic controlling device according to an embodiment of the present invention includes: a power supply control circuit generating a second power based on a first power in response to input of a first trigger signal or a second trigger signal; and a device control circuit operating based on the second power, operating in a first operating mode if activated in accordance with the first trigger signal, operating in a second operating mode if activated in accordance with the second trigger signal, and outputting a shutdown signal to stop generation of the second power with the power supply control circuit after a predetermined operation in the first operating mode or the second operating mode.

### BACKGROUND OF THE INVENTION

1. Field of the Invention

The present invention relates to an electronic controlling device and a method of controlling the same. In particular, the invention relates to an electronic controlling device having such a function as to turn off the power of a system if not particularly needed to operate and to start up if receiving trigger signals through an external switch or a communication line, in accordance with any of the trigger signals, and a method of controlling the same.

2. Description of Related Art

In recent years, the electronic controlling device has proceeded toward reduction of the total power consumption by saving power consumption of incorporated semiconductor devices (IC: integrated circuits). Further, among the ICs incorporated to the electronic controlling device, ICs that need not to operate in the system are put to a power-saving mode such as a standby mode to thereby save the total power consumption of the electronic controlling device. However, in an electronic controlling device driven by a battery, the battery is discharged due to a standby current consumed in the standby mode albeit slowly, even in the standby mode. This results in a problem that a device driving period is shortened.

Japanese Unexamined Patent Publication No. 2003-63102 discloses a technique as a solution to the above problem. FIG. 7 is a circuit diagram of a conventional electronic controlling device disclosed in Japanese Unexamined Patent Publication No. 2003-63102. As shown in FIG. 7, the conventional electronic controlling device operates while supplied with power from a battery BATT101, and includes switches SW101 and SW102, a capacitor C1, resistors R101 to R103, switch transistors Q1 and Q2, a diode D1, a regulator 101, a microcomputer 102, and a circuit block 103. Here, the switches SW101 and SW102 are SPDT switches operating in conjunction with each other.

First, if the switches SW101 and SW102 are turned OFF (terminals A and C are connected together), charges are accumulated in the capacitor C1 through charging of the battery BATT101. Further, a gate of the switch transistor Q1 is connected to a positive terminal of the battery BATT101 through the resistor R101, so the switch transistor Q1 becomes nonconducting. As a result, the power supply to the regulator 101 is stopped, and the regulator 101 stops operations. Along with this, the microcomputer 102 and the circuit block 103 operating with the power VCC generated by the regulator 101 stop operations.

Next, description is given of the case where the switches SW101 and SW102 are turned ON (terminals B and C are connected together). After the switches SW101 and SW102 are switched from OFF to ON, the charges accumulated in the capacitor C1 flow to the switch transistor Q2 through the resistor R102. As a result, the switch transistor Q2 becomes conducting, and a voltage of a gate of the switch transistor Q1 is lowered. Thus, the switch transistor Q1 becomes conducting. After the switch transistor Q1 becomes conducting, power is supplied to the regulator 101 from the battery BATT101, and the regulator 101 generates the power VCC. The microcomputer 102 and the circuit block 103 operate based on the power VCC. In this example, if the circuit block 103 stops operating for a predetermined period or longer, the microcomputer 102 sets a voltage of the power supply control port to a low level (for example, ground voltage). The power supply control port is connected to a base of the switch transistor Q2 through the diode D1. That is, the switch transistor Q2 becomes nonconducting if the voltage of the power supply control port is shifted to a low level. In this way, the gate voltage of the switch transistor Q1 is equal to the voltage of the battery BATT 101, so the switch transistor Q1 becomes nonconducting. If the switch transistor Q1 becomes nonconducting, power supply to the regulator 101 is stopped, and thus power supply to the microcomputer 102 and the circuit block 103 connected with the regulator 101 is stopped.

That is, the conventional electronic controlling device as disclosed in Japanese Unexamined Patent Publication No. 2003-63102 sets the switch transistor Q1 conducting to supply power to the electronic controlling device from the regulator in the case of operating the electronic controlling device. Further, if the electronic controlling device stops operating over a predetermined period, the switch transistor Q1 is set nonconducting to thereby stop the power supply to the electronic controlling device. Hence, if the electronic controlling device stops operating over a predetermined period or more, the total power consumption of the electronic controlling device is saved.

However, the conventional electronic controlling device has only one SPDT switch (switches SW101 and SW102), and thus faces a problem in that the electronic controlling device cannot be turned on in accordance with plural conditions, and operations of the electronic controlling device cannot be changed in accordance with these conditions.

In recent electronic controlling devices, if the power supply of a control circuit of the microcomputer is turned off, it is necessary to switch operations and activate the circuit in accordance with where a control signal is input, in some cases. Especially in a control circuit that has a communication terminal and needs to start operations in accordance with a signal from a communication line, in order to detect the signal from the communication line, the control circuit realizes a signal-waiting mode and a power-saving mode by utilizing a standby function that stops only internal operations while the power is being supplied. In other words, in the conventional electronic controlling device, the power supply to the microcomputer cannot be stopped for activating the electronic controlling device in accordance with a signal from the communication line. Therefore, in the case where the electronic controlling device is activated in accordance with the signal from the communication line, a standby current is consumed even in a non-operating period.

### SUMMARY OF THE INVENTION

An electronic controlling device according to an aspect of the present invention includes: a power supply control circuit generating a second power based on a first power in response to input of a first trigger signal or a second trigger signal; and a device control circuit operating based on the second power, operating in a first operating mode if activated in accordance with the first trigger signal, operating in a second operating mode if activated in accordance with the second trigger signal, and outputting a shutdown signal to stop generation of the second power with the power supply control circuit after a predetermined operation in the first operating mode or the second operating mode.

According to another aspect of the invention, a method of controlling an electronic controlling device including a power supply control circuit generating a second power based on a first power, and a device control circuit operating based on the second power, includes: generating the second power with the power supply control circuit in response to input of a first trigger signal or a second trigger signal; and causing the electronic controlling device to operate in a first operating mode if activated in accordance with the first trigger signal, operate in a second operating mode if activated in accordance with the second trigger signal, and output a shutdown signal to stop generation of the second power with the power supply control circuit after a predetermined operation in the first operating mode or the second operating mode.

According to the electronic controlling device of the present invention, the power supply control circuit can be activated in accordance with one of the first trigger signal and the second trigger signal to generate the second power and operate the device control circuit (for example, microcomputer) based on the second power. For example, provided that the first trigger signal is a trigger signal from the external switch, and the second trigger signal is a trigger signal from the communication line, even in the case of stopping power supply to the microcomputer during such a period that the electronic controlling device stops operating, the microcomputer can be activated in accordance with the trigger signal from the communication line. Therefore, according to the electronic controlling device of the present invention, even in the case of activating the electronic controlling device in accordance with the trigger signal from the communication line, the power supply to the microcomputer can be stopped, making it possible to save power consumption when the electronic controlling device is not operating.

Further, according to the electronic controlling device of the present invention, the first operating mode and the second operating mode can be switched in accordance with a trigger signal. That is, only requisite blocks out of functional blocks of the electronic controlling device can be selectively operated based on a type of the trigger signal. Thus, the electronic controlling device of the present invention can be activated while putting unused functional blocks in a power-saving mode (for example, standby mode), whereby power wasted by blocks unnecessary for target operations can be saved even under operating conditions.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a door module system according to a first embodiment of the present invention;

FIG. 2 is a block diagram of a door module of the first embodiment;

FIG. 3 is a flowchart of activating and initializing procedures of the door module of the first embodiment;

FIG. 4 is a flowchart of operations of the door module of the first embodiment;

FIG. 5 is a flowchart of operations of a power supply circuit of the first embodiment;

FIG. 6 shows how the door module of the first embodiment shifts a mode and consumes power; and

FIG. 7 is a circuit diagram of a conventional electronic controlling device.

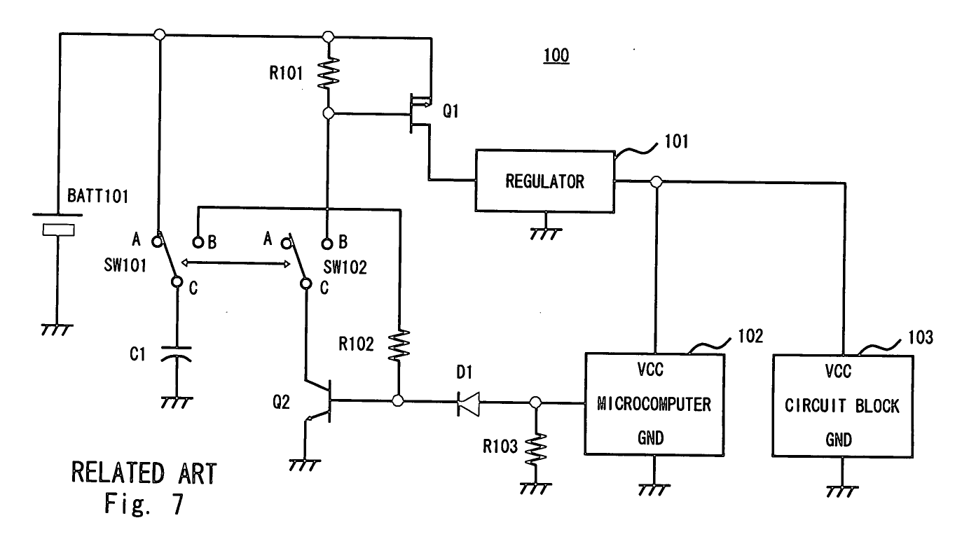

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

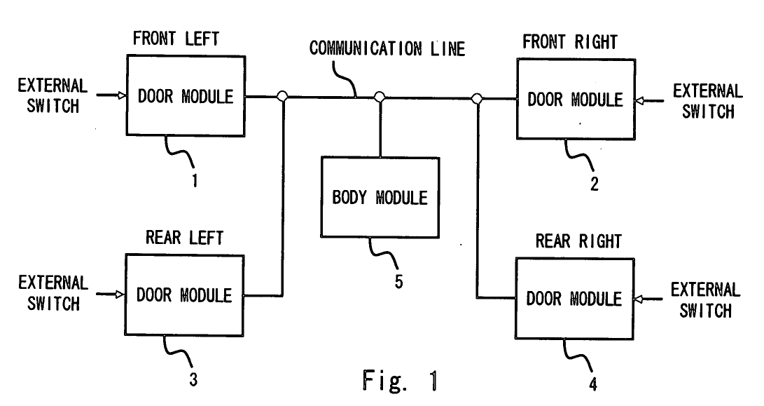

Hereinafter, embodiments of the present invention are described with reference to the accompanying drawings. In this embodiment, description is given of a control module (for example, door module) incorporated in an automobile as an electronic controlling device example. The door module is provided to each of doors of the automobile, and used to control the locking/unlocking of the doors or the opening/closing of windows, for example. Further, the door modules are connected through a communication line in the automobile body. FIG. 1 is a block diagram of the door module system.

As shown in FIG. 1, a door module system of this embodiment has four doors on the front and rear, and right and left sides. The door module system includes door modules 1 to 4, and a body module 5. The door modules 1 to 4 are provided on a passenger-side (front left), a driver's-side (front right), a left-handed backseat (rear left), and a right-handed backseat (rear right), respectively, to control the respective doors in accordance with signals from a corresponding external switch or communication line. The body module 5 executes control on the automobile body, for example.

The door modules 1 to 4 and the body module are connected via a communication line in the automobile body. Through the communication line in the automobile body, a predetermined module sends/receives a control signal to/from another module.

Here, an operation of the door module is described taking the passenger-side door module 1 as an example. The door module 1 has a first operating mode (switch-induced operating mode) where a user (driver or passenger) manipulates a switch directly connected with the door module 1, and the door module 1 operates in accordance with the manipulation, and a second operating mode (communication-induced operating mode) where the door module 1 receives control data from another module to thereby operate.

Regarding the control in the switch-induced operating mode, the passenger-side door is controlled based on a signal from the switch directly connected with the door module 1. This control is executed over, for example, a window lift mechanism for opening/closing a window, a window lock mechanism for locking the window, and a door lock mechanism for locking/unlocking a door.

Incidentally, the switch-induced operating mode may include a mode where the door module 1 sends control data to another module in accordance with the manipulation of the switch directly connected with the door module 1.

Regarding the control in the communication-induced operating mode, the passenger-side door is controlled in accordance with a control signal sent from another module to the door module 1. This control includes, for example, side mirror control for adjusting the angle of side mirrors and switch locking control for disabling a switch provided to a door, in addition to the control on the window lift mechanism, the window lock mechanism, and the door lock mechanism in accordance with a control signal sent from, for example, the driver's-side door module 2.

In this example, the door module 1 can operate with a local control function alone, in the switch-induced operating mode. On the other hand, the door module 1 can operate with a network control function alone, in the communication-induced operating mode.

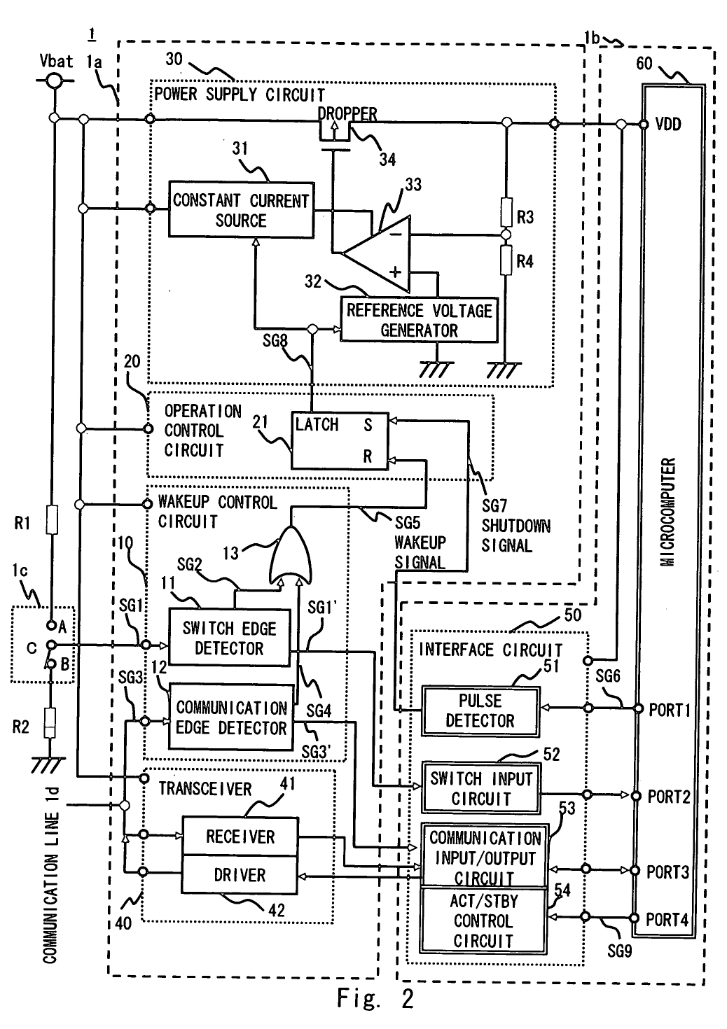

Hence, the door module 1 changes the function depending on which mode is selected. Thus, power consumption can be saved even under operating conditions, by putting a circuit of an unused function into a standby state. FIG. 2 is a block diagram of the door module 1 and is referenced to detail the door module 1.

As shown in FIG. 2, the door module 1 includes a power supply control circuit 1a, a device control circuit 1b, an external switch 1c, and a communication line 1d.

The power supply control circuit 1a operates in accordance with a first power (for example, battery voltage Vbat) and is being supplied with a power as long as connected with a battery. Further, the power supply control circuit 1a generates a second power (for example, power supply voltage VDD) in accordance with a first trigger signal (for example, switch-induced operation signal SG1) or a second trigger signal (for example, communication-induced operation signal SG3) input from the external switch 1c, and stops generation of the power supply voltage VDD in accordance with a shutdown signal SG7 input from the device control circuit 1b. The power supply control circuit 1a is described below in more detail. The power supply control circuit 1a includes a first control circuit (for example, wake-up control circuit 10), a second control circuit (for example, operation control circuit 20), a power supply circuit 30, and a transceiver 40.

The wake-up control circuit 10 includes a switch edge detector 11, a communication edge detector 12, and an OR circuit 13. The switch edge detector 11 detects a rising edge of the switch-induced operation signal SG1 from the external switch 1c, for example, to output a switch edge detection signal SG2. Further, in the case of detecting a rising edge of the switch-induced operation signal SG1, the switch edge detector 11 sends a first trigger notification signal (for example, switch-induced operation notification signal SG1′) to a switch input circuit 52 as described later. Here, the external switch 1c is, for example, a door controlling switch directly connected with the door module 1, and has terminals A, B, and C. The switch is shifted between a state (ON state) where the terminals A and C are connected and a state (OFF state) where the terminals B and C are connected. Further, a resistor R1 is connected between the terminal A and the battery, and a resistor R2 is connected between the terminal B and the ground voltage.

The communication edge detector 12 detects, for example, a rising edge of the communication-induced operation signal SG3 input through the communication line 1d to output a communication edge detection signal SG4. Further, in the case of detecting the rising edge of the communication-induced operation signal SG3, the communication edge detector 12 sends a second trigger notification signal (for example, communication-induced operation notification signal SG3′) to a communication input/output circuit 53 as described later. The OR circuit 13 outputs a wake-up signal SG5 when receiving either the switch edge detection signal SG2 or the communication edge detection signal SG4. That is, the wake-up control circuit 10 outputs a wake-up signal SG5 if either the switch-induced operation signal SG1 or the communication-induced operation signal SG3 is input.

The operation control circuit 20 sends an operation switching signal SG8 for switching a state of the power supply circuit 30 between an operating state and a suspend state in accordance with the wake-up signal SG5 and the shutdown signal SG7 output from the pulse detector 51. In this embodiment, the operation control circuit 20 includes a set/reset latch (SR latch) 21. When a rising edge of a signal is detected at a set (S) terminal, for example, the SR latch 21 outputs a high-level signal (for example, battery voltage Vbat). When a rising edge of a signal is detected at a reset (R) terminal, for example, the SR latch 21 outputs a low-level signal (for example, ground voltage). In this embodiment, the shutdown signal SG7 is input to the set (S) terminal of the SR latch 21, and the wake-up signal SG5 is input to the reset (R) terminal. Detailed description about the shutdown signal SG7 is given below.

The power supply circuit 30 is connected with the battery to generate a power supply voltage VDD as a stepped-down voltage of the battery voltage Vbat. Further, the power supply circuit 30 switches between an operating state and a suspend state in accordance with the operation switching signal SG8 from a second control circuit (for example, operation control circuit 20).

The power supply circuit 30 includes a constant current source 31, a reference voltage generator 32, an amplifier 33, a dropper 34, and resistors R3 and R4. The constant current source 31 operates based on the battery voltage Vbat and switches between an operating state and a suspend state in accordance with the operation switching signal SG8. The reference voltage generator 32 generates a reference voltage at a predetermined level, and switches between an operating state and a suspend state in accordance with the operation switching signal SG8. The amplifier 33 operates in accordance with a current supplied from the constant current source 31. Further, a positive terminal of the amplifier 33 is connected with a reference voltage generator 32. A resistor R4 is connected between a negative terminal and the ground voltage. The resistor R3 is connected between the negative terminal and an output terminal of the power supply circuit 30. An output terminal of the amplifier 33 is connected with a gate of a dropper 34. That is, the power supply circuit 30 amplifies the reference voltage in accordance with a resistance ratio between the resistor R3 and the resistor R4 to output the amplified voltage as the power supply voltage VDD. In this example, the dropper 34 is, for example, a PMOS transistor with a source connected with the battery and a drain used as an output of the power supply circuit 30.

The transceiver 40 operates in accordance with the battery voltage Vbat to transmit/receive control data through the communication line. The transceiver 40 includes a receiver 41 and a driver 42. The transceiver 40 receives input control data with the receiver 41, and transmits control data sent from a microcomputer 60 with the driver 42.

The device control circuit 1b includes an interface circuit 50, and the microcomputer 60. The device control circuit 1b controls the door module 1, and the microcomputer 60 controls functional blocks (not shown) connected with the microcomputer 60 in accordance with a signal from the external switch 1c or control data input through the communication line 1d.

The interface circuit 50 operates in accordance with the power supply voltage VDD. The interface circuit 50 includes a pulse detector 51, a switch input circuit 52, a communication input/output circuit 53, and an ACT/STBY control circuit 54. Incidentally, this embodiment describes the microcomputer 60 and the interface circuit 50 as different blocks, but the microcomputer 60 may include the interface circuit 50 or the power supply control circuit 1a may include the interface circuit 50.

The pulse detector 51 detects the length of such a period that a pulse of a stop signal SG6 output from the microcomputer 60 is kept at high level (for example, power supply voltage VDD). If the pulse is kept at high level for a predetermined period or longer, the pulse detector 51 outputs a shutdown signal SG7. Receiving the switch-induced operation notification signal SG1′, the switch input circuit 52 outputs a high-level signal to the microcomputer 60 through the switch input circuit 52 after starting the device control circuit 1b. That is, the switch input circuit 52 notifies the microcomputer 60 that the door module 1 starts operating, as the external switch 1c is switched from the OFF state to the ON state.

Receiving the communication-induced operation notification signal SG3′, the communication input/output circuit 53 is a buffer that outputs a high-level signal to the microcomputer 60 through the communication input/output circuit 53 after the device control circuit 1b starts operating, transmits to the microcomputer communication data input through the receiver 41, and transmits communication data from the microcomputer 60 to the driver 42. The ACT/STBY control circuit 54 puts the communication input/output circuit 53 into a standby mode to an operating mode based on an ACT/STBY control signal SG9 from the microcomputer. For example, if the door module 1 is activated in accordance with the switch-induced operation signal SG1, and thus there is no need to execute communications, the communication input/output circuit 53 is put in the standby mode. Further, when the door module 1 starts operating in accordance with the switch-induced operation signal SG1, and communication is required, or the door module 1 starts operating in accordance with the communication-induced operation signal SG3, the communication input/output circuit 53 is put into the operating mode.

The microcomputer 60 is a circuit operating based on the power supply voltage VDD and controlling the door module 1 based on a stored program, for example. Further, the microcomputer 60 sends/receives various commands with respect to connected functional blocks (not shown). The microcomputer 60 includes ports 1 to 4.

If the microcomputer 60 meets a condition of shifting an operational mode to a power-saving mode, for example, the stop signal SG6 is output from the port 1. The condition of shifting to the power-saving mode is such a condition that the microcomputer 60 could be put into a suspend state, for example, an operation is completed based on the external switch 1c or control data, or an operation is suspended for a predetermined period or longer. The port 2 receives an output signal from the switch input circuit 52. If this port is applied with a high-level signal, the microcomputer 60 operates in the switch-induced operating mode. The port 3 is connected with the communication input/output circuit 53. For example, if this port receives a high-level signal from the communication input/output circuit 53, the microcomputer 60 operates in the communication-induced operating mode. Further, if control data is received through the communication line 1d, the microcomputer 60 operates based on the communication data. In the case of sending control data, the control data is sent from the port 3 to the communication input/output circuit 53. The port 4 sends the ACT/STBY control signal SG9 to the ACT/STBY control circuit 54 in accordance with the type of control.

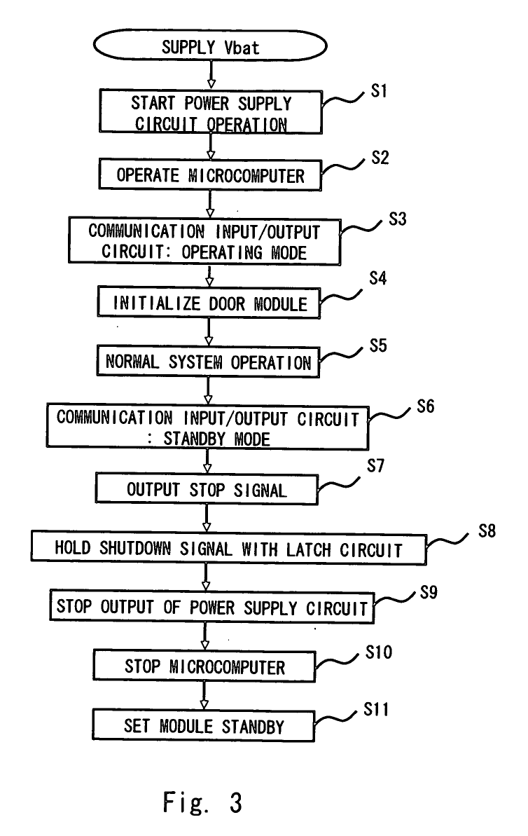

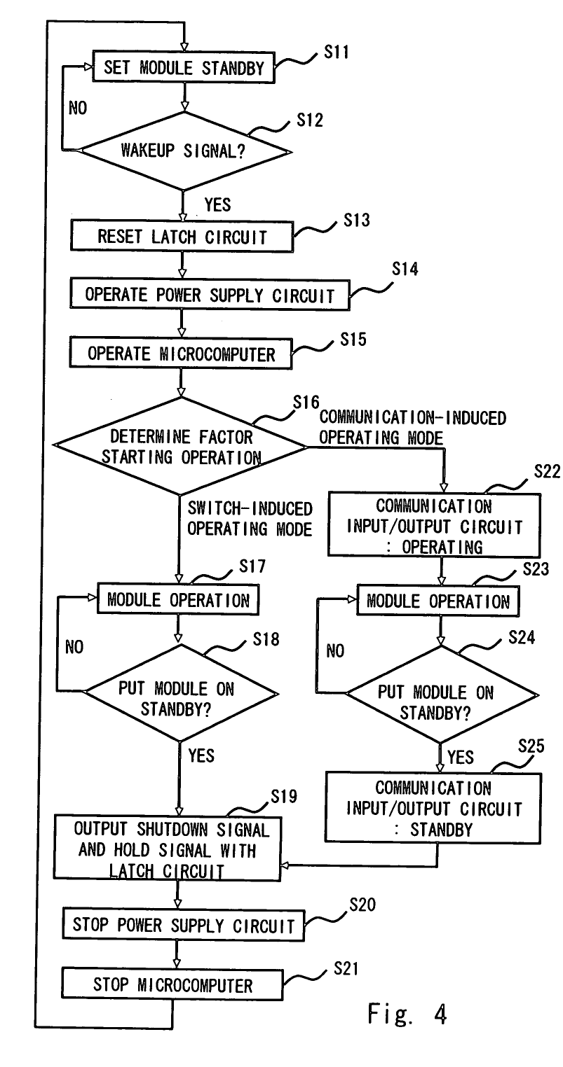

The door module 1 of this embodiment is described below in detail. When a battery is mounted to an automobile, the door module 1 operates while being supplied with power from the battery. For example, the door module 1 starts initialization just at a point in time when the battery is mounted to start supplying power, and is then put on standby to wait for the switch-induced operation signal SG1 or the communication-induced operation signal SG3 to input. If either signal is input, the door module 1 is started to control the door. FIG. 3 is a flowchart of initialization of the door module 1. FIG. 4 is a flowchart of operations from the standby state to the reception of the signal and control of the door.

First, the initialization of the door module 1 is described with reference to FIG. 3. As shown in FIG. 3, when the battery is mounted to the automobile, the battery voltage Vbat is supplied. Thus, the power supply circuit 30 starts operating (step S1), and the microcomputer 60 is supplied with power to thereby operate the microcomputer 60 (step S2). When the microcomputer 60 operates, the communication input/output circuit 53 enters the operating mode for operation confirmation (step S3).

Through steps S1 to S3, blocks of the door module 1 can operate, and then the door module 1 starts initialization (step S4). The initialization makes it possible to set which edge of the rising edge and the falling edge is detected by the switch edge detector 11, for example. In this embodiment, the circuit is set to detect the rising edge.

After the initialization of the door module 1 is completed in step S4, the door module 1 can perform a normal operation in accordance with control data received through the external switch 1c or the communication line 1d (step S5). After that, the microcomputer 60 brings the communication input/output circuit 53 to a standby mode to put the door module on standby (step S6). Subsequently, the microcomputer 60 outputs the stop signal SG6 (step S7). As a result, the shutdown signal SG7 is input to the SR latch 21 of the operation control circuit 20, so the operation switching signal SG8 is set at low level and held (step S8). If the operation switching signal SG8 is at low level, the output of the power supply circuit 30 is stopped (step S9). When the output of the power supply circuit 30 is stopped, the supply of the power supply voltage VDD is stopped, so the microcomputer 60 and the interface circuit 50 are stopped (step S10). Hence, the door module 1 is put on standby to wait for the switch-induced operation signal SG1 or the communication-induced operation signal SG3 to input (step S11).

Next, the normal operation of the door module 1 is explained with reference to FIG. 4. The door module 1 is put on standby to wait for the switch-induced operation signal SG1 or the communication-induced operation signal SG3 to input (step S11). Here, if the switch-induced operation signal SG1 or the communication-induced operation signal SG3 is input, the wake-up control circuit 10 sends the wake-up signal SG5 (step S12). Thus, the SR latch 21 of the operation control circuit 20 is reset to switch the operation switching signal SG8 from a low level to a high level (step S13).

In step S13, the power supply circuit 30 is brought into an operating state and thus, outputs the power supply voltage VDD (step S14). Sequentially, the microcomputer 60 operates based on the power supply voltage VDD (step S15). Here, the microcomputer 60 determines a factor that starts operations to select the switch-induced operating mode or the communication-induced operating mode (step S16). This determination is carried out based on the switch-induced operation notification signal SG1′ in accordance with a level of a signal output from the switch input circuit 52 or based on the communication-induced operation notification signal SG3′ in accordance with a level of a signal output from the communication input/output circuit 53. For example, if the switch input circuit 52 outputs a high-level signal, the door module 1 is put into the switch-induced operating mode. If the communication input/output circuit 53 outputs a high-level signal, the door module 1 is put into the communication-induced operating mode.

First, operations in the switch-induced operating mode are described. In the switch-induced operating mode, the communication input/output circuit 53 does not need to operate, the communication input/output circuit 53 is held in the standby mode. Subsequently, the microcomputer 60 controls the door module 1 based on control data of the external switch 1c (step S17). After the completion of controlling the door module 1, the microcomputer 60 shifts the door module 1 to the standby state (step S18). Subsequently, the microcomputer 60 outputs the stop signal SG6. The pulse detector 51 outputs the shutdown signal SG7 based on the stop signal SG6, and the shutdown signal SG7 is held in the SR latch 21 (step S19). Thus, the SR latch 21 sets the operation switching signal SG8 to a low level, and then the power supply circuit is thereby stopped (step S20). By stopping the supply of the power supply voltage VDD, the microcomputer 60 and the interface circuit 50 are stopped (step S21). Through the operations in steps S19 to S21, the door module 1 is put on standby. Further, this standby state is the standby state of step S11. Incidentally, in the operation of step S17, even in the switch-induced operating mode, the communication input/output circuit 53 may operate to send control data to another module through the communication line.

Next, operations of the communication-induced operating mode are described. In the communication-induced operating mode, the communication input/output circuit 53 needs to operate, so the microcomputer 60 shifts the communication input/output circuit 53 to the operating mode (step S22). Next, the microcomputer 60 receives control data from the communication line 1d through the receiver 41 and the communication input/output circuit 53, and controls the door module 1 based on the control data (step S23). If completing the control over the door module 1 or detecting that another door module is designated by the control data, the microcomputer 60 puts the door module 1 on standby (step S24). Further, if the control data includes information suggesting a standby state, the door module 1 may be shifted to a standby state.

The shift of the door module 1 to the standby state is described next. First, the microcomputer 60 outputs the ACT/STBY control signal SG9 to put communication input/output circuit 53 on standby (step S25). Subsequent operations are similar to the aforementioned operations in steps S20 to S22.

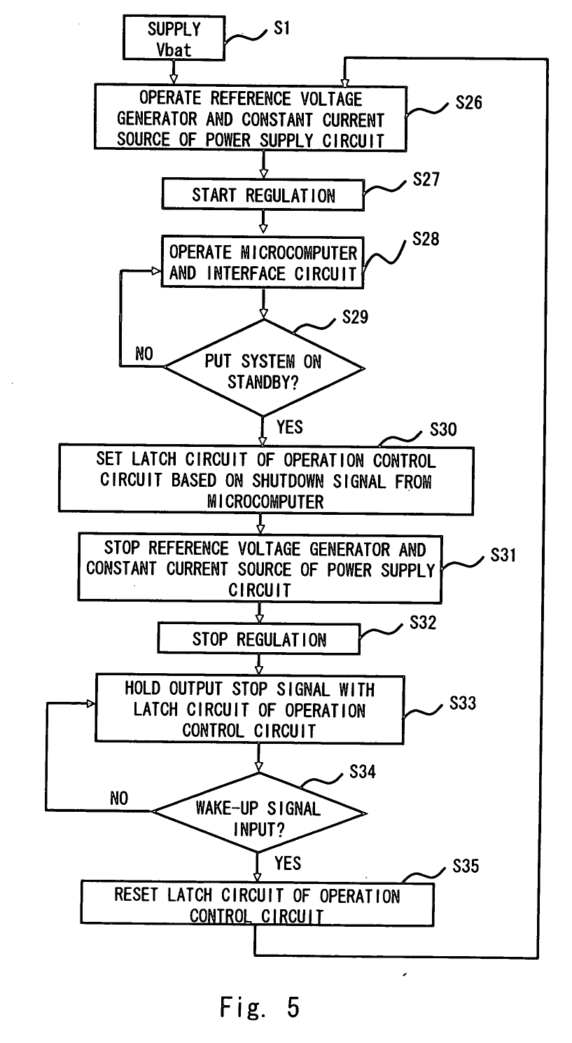

Hereinafter, detailed description is given of the operation of the power supply circuit 30. FIG. 5 is a flowchart of operations of the power supply circuit 30. As shown in FIG. 5, when the power supply circuit 30 is applied with the battery voltage Vbat (step S1), the constant current source 31 and the reference voltage generator 32 operate (step S26). As a result, the power supply circuit 30 is put into an operating state to start regulation (output the power supply voltage VDD) (step S27). The microcomputer 60 and the interface circuit 50 operate thereby (step S28). Subsequently, the microcomputer 60 decides to put the door module 1 on standby (step S29), and then the microcomputer 60 outputs the stop signal SG6. Based on the stop signal SG6, the pulse detector 51 outputs the shutdown signal SG7, and the output voltage of the SR latch 21 is shifted from a high level to low level (step S30).

Due to an operation of step S35, the operation switching signal SG8 is switched to a low level, so the reference voltage generator 32 and constant current source 31 of the power supply circuit 30 are stopped (step S31) The power supply circuit 30 stops regulation (step S32). After that, the SR latch 21 holds the shutdown signal SG7 (step S33), and the input of the switch-induced operation signal SG1 or the communication-induced operation signal SG3 is waited (step S34). That is, the state of steps S38 and S39 is the standby state of the door module 1. Thereafter, receiving the switch-induced operation signal SG1 or the communication-induced operation signal SG3, the wake-up control circuit 10 outputs the wake-up signal SG5 to reset the SR latch 21 and switch the operation switching signal SG8 to a high level (step S31). Accordingly, the power supply circuit 30 returns back to the operation of step S26.

As understood from the above description, the door module 1 of this embodiment activates the power supply circuit 30 to generate the power supply voltage VDD in the case of receiving either the switch-induced operation signal SG1 or the communication-induced operation signal SG3, by which the microcomputer 60 and the interface circuit 50 are activated to operate the door module 1. Further, the operation of the door module 1 can be changed in accordance with which of the switch-induced operation signal SG1 and the communication-induced operation signal SG3 is used to start the door module 1. In this embodiment, if the door module 1 is driven in the switch-induced operating mode based on the switch-induced operation signal SG1, the door module 1 starts operating while the communication input/output circuit 53 is put on standby. In contrast, if the door module 1 is driven in the communication-induced operating mode based on the communication-induced operation signal SG3, the door module 1 starts operating while the communication input/output circuit 53 is set to the operational mode. Hence, the door module 1 of this embodiment can put the unused communication input/output circuit 53 on standby, in the switch-induced operating mode, making it possible to save the power consumption under operating conditions.

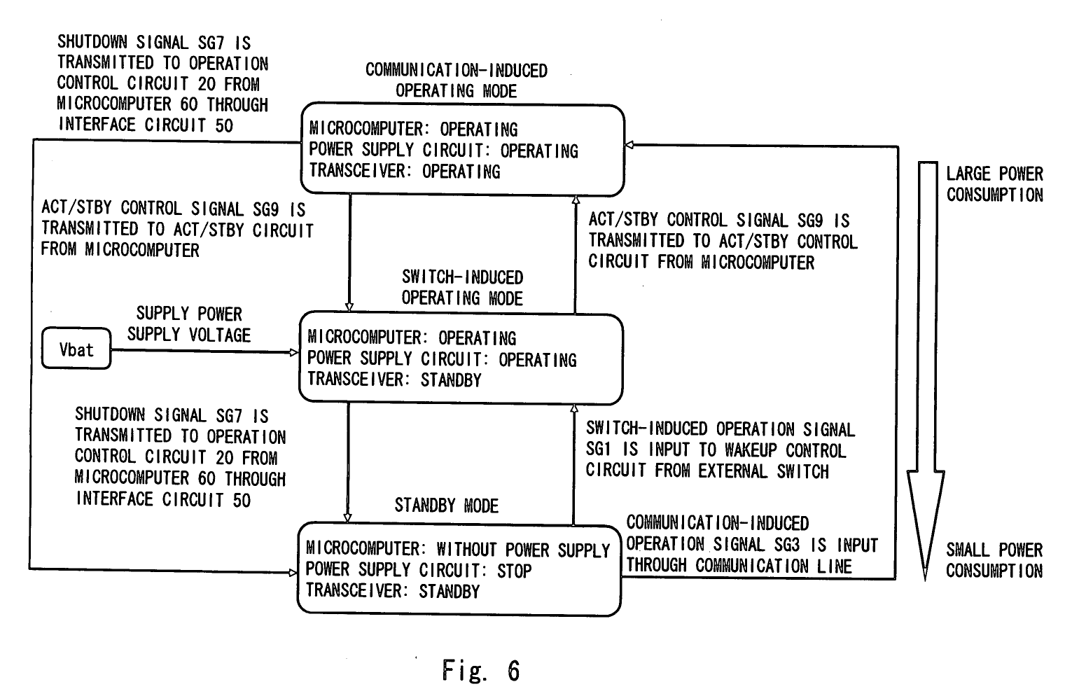

FIG. 6 shows a relation between the shift of a mode of the door module 1 and the power consumption. Referring to FIG. 6, the relation between the shift of a mode of the door module 1 and the power consumption is described below. Supplied with the battery voltage Vbat, the door module 1 starts operating in the switch-induced operating mode, and is then shifted to the communication-induced operating mode for initialization and then to the standby mode.

After the completion of the initialization, its state is shifted based on the switch-induced operation signal SG1, the communication-induced operation signal SG3, the shutdown signal SG7, and the ACT/STBY control signal SG9. To describe consumed power in each mode of the door module 1, as shown in FIG. 6, the power consumption is largest in the communication-induced operating mode, followed by the switch-induced operating mode and the standby mode in this order. Regarding a conventional electronic controlling device, the device can only operate with the standby mode and a mode similar to the communication-induced operating mode of this embodiment. Thus, during the operation in the switch-induced operating mode of this embodiment, the communication input/output circuit 53 waists the power.

To mention power consumption of an electronic controlling device, for example, as for a conventional electronic controlling device including a power supply circuit that cannot stop operations, all blocks are operating in an operating mode, consumed power is several tens of mA. In a standby mode, a microcomputer and a communication input/output circuit are put on standby, so the two blocks each consume power of several tens of μA. In contrast, as for the door module 1 of the present invention, all blocks are operating while consuming power of several tens of mA in the communication-induced operating mode. In the switch-induced operating mode, the power consumed by the communication input/output circuit 53 can be reduced from several mA to several tens of μA. Further, in the standby mode, an operation of the power supply circuit 30 can be stopped, so the power consumption of the microcomputer and the communication input/output circuit 53 can be reduced to 0A.

In summary, according to the door module 1 of the present invention, even in the case of operating the microcomputer 60 in accordance with a signal from the communication line, a power supply control circuit for generating a power to be supplied to the microcomputer 60 can be activated in response to either the signal from the external switch 1c or the signal from the communication line. Thus, even if the power supply to the microcomputer 60 is stopped during such a period that the door module 1 is not operating, the microcomputer 60 can be driven in accordance with a signal from the communication line. Therefore, the power consumption during a period where the door module 1 is not operating can be saved.

Further, according to the door module 1 of the present invention, it is possible to save power wasted in an unused circuit under operating conditions as well as power consumption in the standby state. The door module 1 or other such electronic controlling devices are effective for a system where a battery having a limited charging capacity is connected all the time, and power charged in the battery is continuously consumed like a module mounted to an automobile. In recent years, a number of modules are mounted to an automobile. A power saving effect of the electronic controlling device of the present invention is particularly large in such a case.

Incidentally, as another embodiment of the present invention, although the two signals, the signal from the external switch and the signal from the communication line, are used to switch the operation after the start-up in the above embodiment, such signals are not limited to two types, and two or more types of signals may be used. Further, in the above description, the switch 1c of the present invention is a single switch. However, it is possible to provide plural switches and activate the power supply control circuit 1a based on a signal from any of the switches. In addition, although not particularly described in the above embodiment, the power supply control circuit and the device control circuit may be combined on a single chip as a semiconductor integrated circuit or embedded to different chips.

It is apparent that the present invention is not limited to the above embodiment that may be modified and changed without departing from the scope and spirit of the invention.

What is claimed is:

1. An electronic controlling device, comprising:
a power supply control circuit generating a second power based on a first power in response to input of a first trigger signal or a second trigger signal; and
a device control circuit operating based on the second power, operating in a first operating mode if activated in accordance with the first trigger signal, operating in a second operating mode if activated in accordance with the second trigger signal, and outputting a shutdown signal to stop generation of the second power with the power supply control circuit after a predetermined operation in the first operating mode or the second operating mode.

2. The electronic controlling device according to claim 1, wherein the power supply control circuit includes:
a first control circuit detecting that the first trigger signal or the second trigger signal is input and outputting a wake-up signal requesting generation of the second power;
a power supply circuit generating the second power based on the first power; and
a second control circuit operating the power supply circuit in accordance with the wake-up signal and stopping the power supply circuit in accordance with the shutdown signal.

3. The electronic controlling device according to claim 2, wherein the first control circuit further outputs a first trigger notification signal notifying the device control circuit that the input of the first trigger signal is detected.

4. The electronic controlling device according to claim 2, wherein the second control circuit keeps an output voltage corresponding to the shutdown signal until the wake-up signal is input, and keeps an output voltage corresponding to the wake-up signal after the wake-up signal is input.

5. The electronic controlling device according to claim 1, wherein the first trigger signal is supplied from an external switch connected with the electronic controlling device.

6. The electronic controlling device according to claim 1, wherein the second trigger signal is a communication-induced operation signal that is input from another electronic controlling device through a communication line.

7. The electronic controlling device according to claim 1, wherein the electronic controlling device is a control module incorporated in an automobile.

8. An electronic controlling device, comprising:
a power supply control circuit having an input terminal connected with an external switch and a communication terminal connected with a communication line, and generating a second power based on a first power; and
a device control circuit operating based on the second power,
the power supply control circuit generating the second power in accordance with a first trigger signal applied to the input terminal or a second trigger signal applied to the communication terminal.

9. The electronic controlling device according to claim 8, wherein the electronic controlling device is a control module incorporated in an automobile.

10. A method of controlling an electronic controlling device including a power supply control circuit generating a second power based on a first power, and a device control circuit operating based on the second power, comprising:
generating the second power with the power supply control circuit in response to input of a first trigger signal or a second trigger signal; and
causing the electronic controlling device to operate in a first operating mode if activated in accordance with the first trigger signal, operate in a second operating mode if activated in accordance with the second trigger signal, and output a shutdown signal to stop generation of the second power with the power supply control circuit after a predetermined operation in the first operating mode or the second operating mode.

11. A method of controlling an electronic controlling device including: a power supply control circuit having an input terminal connected with an external switch and a communication terminal connected with a communication line, and generating a second power based on a first power; and a device control circuit operating based on the second power, the power supply control circuit generating the second power in accordance with a first trigger signal applied to the input terminal or a second trigger signal applied to the communication terminal.
